(19) United States
(12) Patent Application Publication
(10) Pub. No.: US 2009/0313807 A1
(43) Pub. Date: Dec. 24, 2009

(54) Cooktop Replacement

(76) Inventor: Narisu Narisu, Gaithersburg, MD (US)

Correspondence Address: Narisu Narisu, 9604 Oyster Point Way, Gaithersburg, MD, 20886, US

(21) Appl. No.: 12/143,764

(22) Filed: Jun. 21, 2008

(51) Int. Cl. B23P 15/00

(52) U.S. Cl. 29/592.1; 29/426.1; 29/428; 29/592

(57) ABSTRACT

This invention allows people to upgrade cooking top of an existing electronic kitchen range to easy to clean, energy efficient glass, ceramic, or stainless steel flat cooktop, while keeping most other features of the old range.

### DESCRIPTION OF INVENTION

An ordinary kitchen range with exposed burners is difficult to clean. There is no easy way to upgrade surface of an ordinary range with glass, ceramic, or stainless steel cooking top. This invention takes advantage of most features of an existing electronic range, and allows people to replace cooking top to easy to clean, energy efficient glass, ceramic, or stainless steel cooktop without sacrificing other features of the old range.

FIG. 1 is an ordinary range. Its top is enlarged in FIG. 2. There are one or more cooking units. Each of them have a heating coil that sits on a pan (FIG. 2). The heating coil is connected to the electrical power socket (FIG. 2). This invention includes the possess of removing heating coil and pan, and attaches one connector to each cooking unit of a flat cooking top. The connector has a head (FIG. 3, bottom view of cooktop surface) that can be connected to the power socket (FIG. 2) of the range. The cooktop thus can be connected to the range by means of any conductor that transmits electricity and is durable for heat. The flat cooktop can have only one cooking unit, or have up to four cooking units. If there is fewer than four cooking units, then the size of the flat cooktop can be smaller and the shape of it can be round. The cooktop then is fastened to the surface of range by means of silicon glue (FIG. 4) or other mechanical ways. The range is upgraded to a range with flat glass, ceramic or stainless steel cooktop. Final product looks like FIG. 4. Each of four cooking units (heating coil with the pan) can be individually replaced by a corresponding shape of flat cooktop with the same feature described above.

This invention allows continued use of existing range, including control panel and accessories, and replaces heating units of the range to easy to clean flat cooktop.

### DRAWINGS

FIG. 1. Ordinary kitchen range

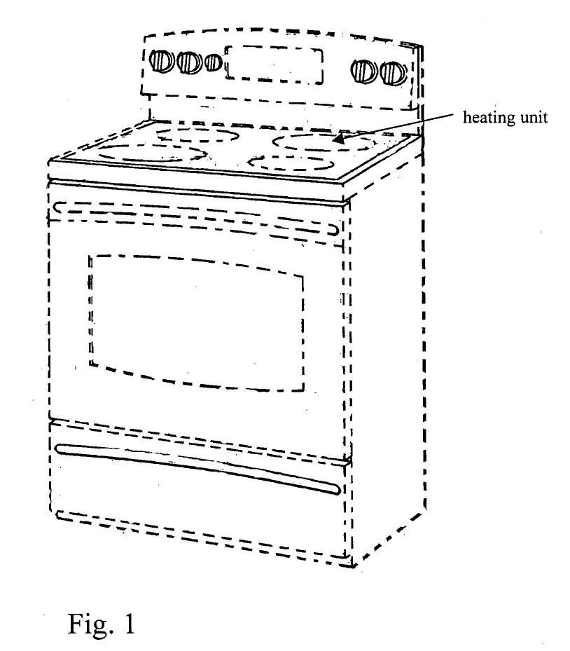

FIG. 2. Top view of enlarged such an old range

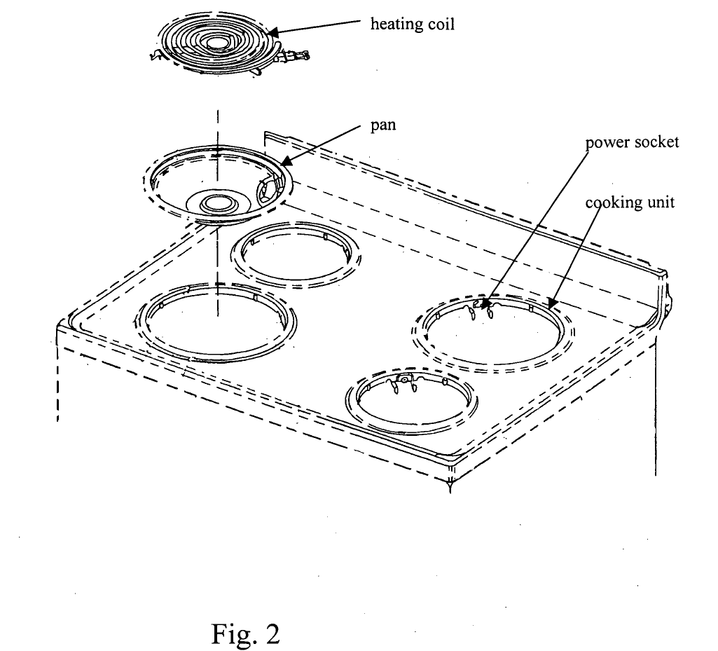

FIG. 3. Bottom view of new cooktop

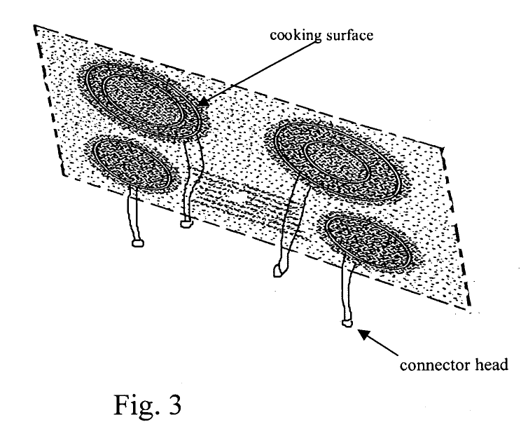

FIG. 4. Finished product.

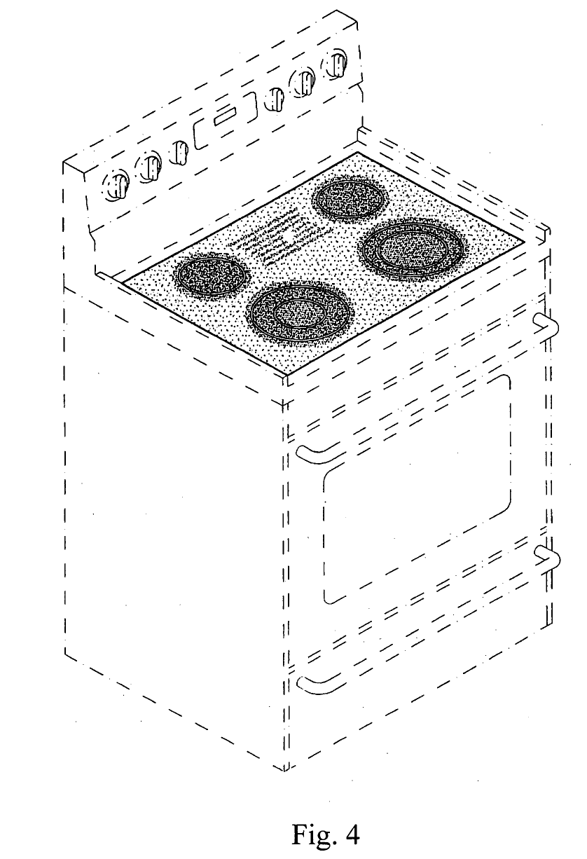

1. Process of removing exposed burners (or heating coil) and pans below of a range while keeping all other parts.

2. Manufacture of heat resistant short electrical connector whose one end could be inserted/connected to an existing power socket (receptacle) in a burner unit of the range and is kept connected.

3. The process of connecting one end of this electrical connector to bottom of a heating unit of a flat cooktop made with glass, ceramic, or stainless steel surface and the other end (head) the existing power socket (receptacle) in each burner unit of a range.

4. Manufacture of a small hole of any shape in the corner of the flat cooktop to allow air flow of the range to outside.

5. Process of placing such a cooking surface on top of the range and mounting the cooktop surface rigidly on top of the range by means of adhesive, or other material.

6. Related to the above claims replacing and updating any shape, or size, or number of heating units of the electronic kitchen range with a corresponding shape, size or number of flat cooktop using similar procedure.
